(19) United States
(12) Patent Application Publication
(10) Pub. No.: US 2026/0143462 A1
(43) Pub. Date: May 21, 2026

(54) Method of Communication

(71) Applicant: Kleemann GmbH, Göppingen (DE)

(72) Inventor: Lukas Bräuninger, Weinstadt (DE)

(21) Appl. No.: 19/385,440

(22) Filed: Nov. 11, 2025

(30) Foreign Application Priority Data
Nov. 15, 2024 (DE) 10 2024 133 450.9

(51) Int. Cl. H04W 64/00; H04W 4/38

(52) U.S. Cl. CPC H04W 64/006; H04W 4/38

(57) ABSTRACT

A method of communication between a material processing device and a mobile device and a method for transmitting a plant state and/or a message relating to a plant state of a material processing device to a mobile device. A simplified and less error-prone connection between the material processing device and the mobile device is achieved by determining the availability of a wireless connection based on location data of the material processing device and of the mobile device. An improved method for transmitting a plant state and/or a message concerning a plant state of a material processing device to a mobile device is provided by transmitting the plant state and/or the message concerning the plant state to the mobile device via a wireless connection and/or to an external data processing device via a further wireless connection.

### RELATED APPLICATIONS

The present application claims priority to German Patent Appl. Ser. No. DE 102024 133 450.9 filed Nov. 15, 2024, which is incorporated herein by reference.

### BACKGROUND OF THE DISCLOSURE

### Field of the Disclosure

The disclosure relates to a method of communication between a material processing device and a mobile device and a method for transmitting a plant state and/or a message relating to a plant state of a material processing device to a mobile device.

### Description of the Prior Art

DE 10 2022 118 039 B3 (US 2024/024890) discloses a material processing device in the form of a rock processing device having an impact crusher, a pre-screen and a post-screen. The rock processing device is used for crushing and sizing rock material. Processed material is sorted by size and piled up and stockpiled in various heaps. The rock processing device has a control device that is connected to a data memory for data exchange. Furthermore, an input device for inputting and an output device for outputting information are provided. The output device is also in radio communication having a receiving device for receiving and transmitting data. The control device determines various data, for instance when the next feed of material to be processed is to take place on the feed unit of the rock processing device or when a stockpile of processed material is to be cleared the next time. The relevant information is sent to a mobile receiving device, which is available to a machine operator, for instance of an excavator for feeding material or a wheel loader for clearing the stockpile. The mobile receiving device can be a cell phone, for instance.

Using methods of communication known from the prior art between material processing devices and mobile devices, difficulties arise in particular when a mobile device is used to communicate with more than one material processing device. In such a case, for instance, the mobile device will always try to establish a connection with the last connected material processing device, even if a connection may not be available, in particular if the material processing device is located far away, for instance at a different construction site. Possibly, the mobile device does not directly attempt to connect to the last connected material processing device, but instead provides the user with a selection of connections to material processing devices, to which the mobile device had been connected before. Particularly in the case of mobile devices that had been connected to a large number of material processing devices before, such as mobile devices typically used by customers who operate several systems or by service technicians, there may therefore be a long list of previous connections, which makes selecting the desired material processing device cumbersome and error-prone.

The state of the art also has disadvantages with regard to the transmission of a plant state and/or a message concerning a plant state of a material processing device to a mobile device. For instance, provision may be made for messages regarding the plant state to be transmitted to all mobile devices that had previously been connected to the material processing device. Thus, even mobile devices that are located far away from the material processing device and for whose users the transmitted message is therefore not relevant also receive messages. For instance, a machine operator having a mobile device may be far away from the material processing device and therefore not be able to perform a clearing job or the like. On the other hand, sometimes provision is made for messages about the plant state to be only transmitted to mobile devices that are directly connected to the material processing device, for instance via a wireless connection such as a WiFi network of the material processing device. If a mobile device is now outside the range of such a connection, the message cannot be transmitted to the mobile device or cannot be transmitted in full, in particular even though the user of the mobile device would be eligible to perform a clearing order or the like, for instance because he is at the same construction site as the material processing device.

### SUMMARY OF THE DISCLOSURE

The disclosure addresses the problem of providing a method of communication between a material processing device and a mobile device, which is characterized by a simplified and less error-prone establishment of a wireless connection between the material processing device and the mobile device.

It also addresses the problem of providing an improved method for transmitting a plant state and/or a message relating to a plant state of a material processing device to a mobile device.

The first-mentioned problem is solved by a method wherein provision is made for stored location data of the material processing device to be retrieved from a memory of the mobile device and/or a memory device of an external data processing device and for a location data of the mobile device to be determined.

The stored location data may, for instance, have been transmitted from the material processing device to the mobile device as part of a previous connection, in particular a previous wireless connection. It is also conceivable that the mobile device then transmitted the location data to the external data processing device. It is also conceivable that the material processing device had previously transmitted its location data to the external data processing device and/or that the location data were transferred from the external data processing device to the mobile device.

The stored location data can, for instance, be information regarding the construction site and/or the area of the construction site the material processing device or mobile device is located. It is also conceivable that an address of the location of the material processing device or of the mobile device is determined. Location data that contain a form of coordinates, for instance in relation to a global or local coordinate system, are also conceivable. Preferably, the location data can contain or relate to geographical coordinates.

Further, provision is made for an availability of a wireless connection between the material processing device and the mobile device to be determined at least partially on the basis of the location data of the mobile device and the stored location data of the material processing device. For instance, a determination based on location data can include determining the distance between the potential connection partners. In particular, a small distance can result in the determination that a wireless connection is available, a large distance in the determination that no wireless connection is available.

The method according to the disclosure also provides for the wireless connection to be established if available. For instance, the connection can be established automatically once the availability of the wireless connection has been determined. It is also conceivable to establish the wireless connection manually once availability has been determined.

If provision is made, after the wireless connection has been established, for current location data of the material processing device to be transmitted from the material processing device to the mobile device via the wireless connection and to be stored in a memory of the mobile device, a reconnection of the material processing device and the mobile device can be facilitated. For instance, when a mobile device is first connected to a material processing device, to which the mobile device was not previously connected, the material processing device can transmit its current location data to the mobile device. The initial connection can be established, for instance, in accordance with the method according to claim 1 or alternatively by a different method, in particular by manually establishing a connection, for instance by entering connection data such as a wireless connection identifier and a password or the like. The mobile device stores the location data of the material processing device and can access it when a new connection to this material processing device is to be established. Preferably, the material processing device can again transmit its current location data to the mobile device during this reconnection. The mobile device can then save these location data or update the location data saved during the initial connection or a previous connection. The availability of the wireless connection can then be determined based on the location data of the material processing device stored in the memory of the mobile device and the location data of the mobile device.

In this context, advantageously provision may also be made for the current location data of the material processing device to be transmitted from the mobile device to the external data processing device via a second wireless connection. The current location data can then be stored in the memory device of the external data processing device. In this way, current location data of the material processing device can also be made available for retrieval to other mobile devices via the external data processing device. This can be particularly advantageous if the location data of the material processing device has changed since an initial connection or a previous connection, for instance because the location of the material processing device has changed. To this end it is conceivable that in the meantime another mobile device, for instance of another user, has been connected to the material processing device and has transmitted more up-to-date location data of the material processing device to the external data processing device. The determination of the availability of the wireless connection can thus take into account updated location data of the material processing device. To this effect, the location data of the material processing device can be continuously updated, in particular every time the mobile device or another mobile device is in contact with the material processing device.

Alternatively or additionally, in accordance with an advantageous further development of the disclosure, proposition is made for the current location data of the material processing device to be transmitted from the material processing device to the external data processing device via a third wireless connection. The location data can then be stored in the memory device of the external data processing device. In other words, the material processing device can thus directly communicate its location data to the external data processing device such that it can be made available to the mobile device or other mobile devices. In particular, it is conceivable that the material processing device transmits its current location data to the external data processing device at regular or irregular intervals, in case of events such as a change in location, and/or continuously for the purpose of updating the location data stored in the memory device.

In accordance with an advantageous further development of the disclosure, proposition is made for the determination of the current location data of the material processing device to be performed by the material processing device. In particular, the material processing device can have a location sensor for this purpose. Preferably, the location can be determined using a global navigation satellite system, in particular GPS, GLONASS, Beidou or Galileo.

Alternatively or additionally, provision may be made for the location data of the mobile device to be determined by the mobile device. In particular, the mobile device can have a location sensor for this purpose. Preferably, the location can be determined by means of a global navigation satellite system, in particular by means of GPS. Advantageously, commercially available mobile devices often already have location sensors, in particular GPS sensors.

Provision may be made for the mobile device to retrieve the stored location data of the material processing device from the external data processing device via the second wireless connection.

The availability of a wireless connection between the mobile device and the material processing device can be determined in a simple and reliable manner if a geographical distance between the mobile device and the material processing device is taken into account. For instance, the stored location data of the material processing device and the location data of the mobile device can be used to determine the geographical distance, for instance in a unit of length such as meters. The geographical distance can be determined, for instance, by the mobile device and/or the external data processing device. In particular, provision may be made for the determination of availability to lead to the result that a wireless connection is available if the geographical distance between the material processing device and the mobile device is smaller than a predetermined geographical distance. The specified geographical distance can, for instance, be a value such as 100 m, 50 m or 20 m. It is conceivable that the predetermined geographical distance takes into account a range of the wireless connection, for instance taking into account a transmission and/or reception power of the material processing device and/or of the mobile device with respect to the wireless connection.

The last-mentioned problem is solved by a method wherein provision is made for a plant state of the material processing device to be determined. If there is a wireless connection between the material processing device and the mobile device, the plant state and/or a message regarding the plant state is/are sent to the mobile device via the wireless connection. Alternatively or additionally, provision is made for the plant state and/or the message concerning the plant state to be transmitted to an external data processing device. This may be provided in particular if there is no wireless connection between the material processing device and the mobile device. Transmission via the wireless connection can in and of itself result in a meaningful assignment to the mobile device due to the range of the wireless connection, as a mobile device located in the vicinity of the material processing device receives information about the plant state. The transmission of the plant state and/or the message regarding the plant state to the external data processing device offers the advantage of the information about the plant state being available not only locally limited to the range of the wireless connection. In particular, it is conceivable that the information is provided by the external data processing device in a retrievable form, in particular retrievable for the mobile device. Possibly, the information is actively sent from the external data processing device to the mobile device.

In accordance with a preferred embodiment of the disclosure, provision may be made for the plant state to comprise a measured value of at least one sensor of the material processing device or to depend on the measured value. In particular, the measured value can be a measured value from a stockpile sensor. The stockpile sensor can be used to determine the material level of a stockpile. The stockpile can, for instance, be a stockpile for material previously processed by the material processing device and/or also a stockpile for material to be processed by the material processing device. The measured value can also be a measured value of a conveyor-device sensor. The conveyor-device sensor can be used to determine the flow of material conveyed by the material processing device. The conveyed material may include material to be processed. A discharge-conveyor sensor can also be provided to detect a stream of processed material conveyed by the material processing device. It is also conceivable that a measured value of a feed-material sensor is determined. The feed-material sensor can be used to determine information about material that has been fed to a feed unit of the material processing device for processing. The measured value can also be a measured value from a level sensor. The level sensor can be used to determine the level of a crushing plant and/or a screening plant of the material processing device. Furthermore, the measured value can be a measured value of a crushing-gap sensor, which can be used to determine a current gap width of a crushing gap of the crushing plant. It is also conceivable that an operating-materials sensor is provided, the measured value of which provides information about a supply of operating materials (e.g. fuels, lubricants, coolants, etc.). A state-of-charge sensor can also be provided, which is used to determine the state of charge of an energy storage device, such as a battery or rechargeable battery.

For a meaningful assignment of information regarding the plant state to mobile devices, provision may be made for a geographical distance between the mobile device and the material processing device to be determined on the basis of location data of the material processing device and location data of the mobile device. The location data can, for instance, be location data stored in a memory of the mobile device and/or in a memory device of the external data processing device. The plant state and/or the message concerning the plant state can then be transmitted from the external data processing device to the mobile device via a second wireless connection if the geographical distance is below a predefined value. The geographical distance can be determined, for instance, by the mobile device and/or the external data processing device. The predefined value can, for instance, be a distance that enables the user of the mobile device to perform a task using the material processing device in a meaningful way, such as clearing a stockpile or refilling an operating material. For instance, the distance can be less than 1 km, 500 m, 200 m or less.

In accordance with a preferred variant of the disclosure, proposition is made for the plant state to be compared to a target plant state, and for the message relating to the plant state to be a warning message that signals a deviation between the plant state and the target plant state. The matching of data can be performed by the material processing device, by the mobile device and/or by the external data processing device.

The determination of the plant state, the transmission of the plant state and/or the message concerning the plant state to the mobile device and/or to the external data processing device can occur continuously, at regular intervals or at irregular intervals.

In the context of the disclosure, the material processing device may in particular be a rock processing device. The material processing device can have at least one crushing plant and/or one screening plant and/or one conveyor device. Preferably, the material processing device can be a mobile material processing device.

Such material processing devices can be used, for instance, for crushing and/or sorting feed material, in particular rock material such as natural stone, concrete, bricks, or recycled material. The material to be processed is fed to a feed unit of the material processing device, for instance in the form of a hopper, and fed to a crusher and/or a screen via a conveyor device, for instance a vibratory feeder or a belt conveyor. A pre-screen unit can be installed upstream of the crusher, for instance to pass a fine fraction or a medium fraction, which already has a suitable grain size, past the crusher. The pre-screen unit can be part of the conveyor device.

Furthermore, in the context of the disclosure, the mobile device can be a cell phone, a tablet computer, a personal digital assistant (PDA), an operating interface of a construction machine such as an excavator or wheel loader and/or a notebook.

In the context of the disclosure, the wireless connection between the mobile device and the material processing device can in particular comprise a radio connection, for instance a WiFi, near-field communication, RFID and/or Bluetooth connection.

The second wireless connection between the mobile device and the external data processing device may in particular comprise a radio connection, preferably a mobile radio connection, for instance a GSM, UMTS, LTE, 5G and/or a 6G connection and/or a WiFi connection. The third wireless connection between the material processing device and the external data processing device may in particular comprise a radio connection, preferably a mobile radio connection, for instance a GSM, UMTS, LTE, 5G and/or a 6G connection and/or a WiFi connection.

### BRIEF DESCRIPTION OF THE DRAWINGS

The disclosure is explained in greater detail below based on exemplary embodiments shown in the Figures. In the Figures:

FIG. 1 shows a schematic, partially sectioned view of a material processing device, a mobile device and an external data processing device,

FIG. 2 shows a sequence diagram of an exemplary communication sequence between the material processing device and the mobile device,

FIG. 3 shows a further sequence diagram of an exemplary communication sequence between the material processing device, the mobile device and the external data processing device, and

FIG. 4 shows a sequence diagram of an exemplary sequence for transmitting a plant state and/or a message concerning the plant state of the material processing device to the mobile device.

### DETAILED DESCRIPTION

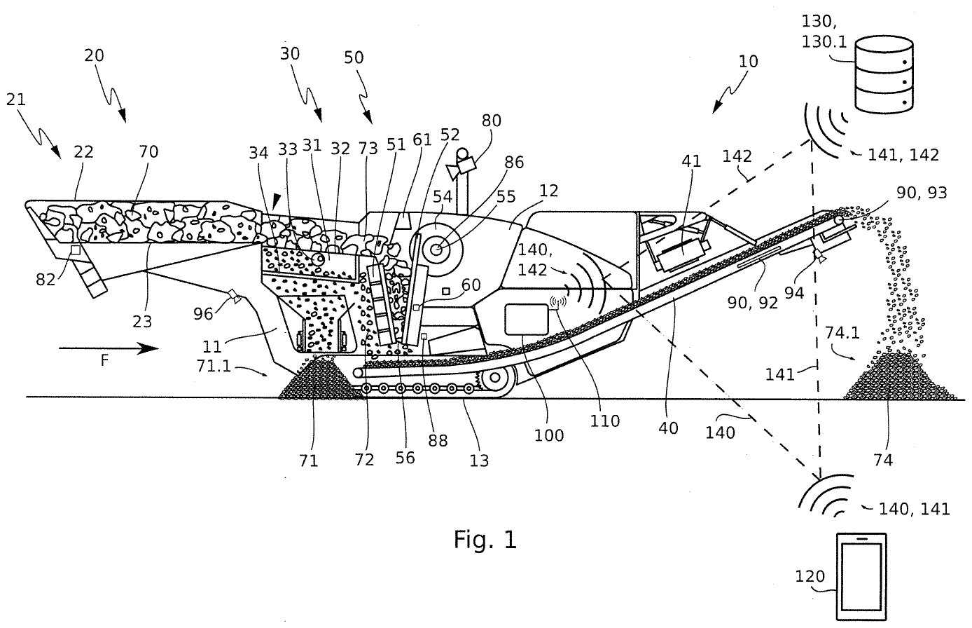

FIG. 1 shows a lateral, partially cut schematic representation of a material processing device 10. The material processing device 10 can be designed as a mobile unit having a chassis 11 and for instance a chain drive 13. The material processing device 10 may comprise a crushing plant 50 and/or a screening plant 30 and/or a stockpile conveyor.
A hopper 21, which may have hopper walls 22, may further be provided at the material processing device 10, in particular at a feed unit 20. The hopper 21 may be used to receive feed material 70 from an upstream conveyor, such as an excavator, wheel loader, or belt conveyor, and direct it onto a conveyor device 23.

The crushing plant 50 and/or the screening plant 30 can be supplied with feed material 70 for processing in a conveying direction F by means of the conveyor device 23. In this case, the conveyor device 23 is designed as a vibratory feeder. However, other embodiments of a conveyor device 23, in particular as a conveyor belt, are also conceivable.

The screening plant 30 may, for instance, be connected upstream of the crushing plant 50 as a pre-screen unit. The pre-screen unit may comprise a heavy-duty double-deck screen 31, which may have an upper deck 32 designed as a coarser screen and a lower deck 34 designed as a finer screen. A drive 33 causes it to vibrate in a circular motion. The upper deck 32 can separate a fine fraction 71 and a medium fraction 72 from the material to be crushed 73. The lower deck 34 can separate the fine fraction 71 from the medium fraction 72. The fine fraction 71 can optionally be routed out of the material crushing system 10 and onto a fines stockpile 71.1 or, for instance, to the medium grain 72 by setting a bypass flap accordingly. The medium fraction 72 can be routed to a main discharge conveyor 40 past the crusher 50 via a bypass. The material to be crushed 73 is routed to the crusher 50 via a crusher inlet at the end of the pre-screen unit. The pre-screen unit may be part of the conveyor device 23.

The material processing device 10 may comprise a crushing plant 50 configured as a jaw crusher. However, it is also conceivable to provide other types of crushing plants 50, for instance impact crushers, gyratory crushers or cone crushers. The crushing plant 50 may comprise a stationary crushing jaw 51 and a moving crushing jaw 52, which may be oriented to converge at an angle such that a tapered shaft is formed therebetween. The shaft may open out into a crushing gap 56. The crushing plant 50 may be driven, for instance by a drive unit 12, via a drive shaft 55 connected to an eccentric 54.

The eccentric 54 moves the moving crushing jaw 52 towards and away from the stationary crushing jaw 51 in an elliptical motion. In the course of such a stroke, the distance between the crushing jaws 51, 52 also changes. The motion of the moving crushing jaw 52 causes the material 73 to be crushed to be crushed further and further along the shaft until it reaches a grain size that allows it to exit the shaft through the crushing gap 56. The crushed material 74 falls onto the main discharge conveyor 40 and is conveyed further onto a main discharge stockpile 74.1. Provision can also be made, for instance, for it to pass a magnetic separator 41, which separates ferromagnetic components from the shredded material 74 and ejects them laterally.

As FIG. 1 further shows, the feed-material processing device 10 may comprise a sensor 80. The feed-material sensor 80 can be used to determine information about the material fed to the feed unit 20. In particular, it can be information about the properties of the material supplied, wherein a property may be, for instance, a feed size and/or type of material to be processed.

It is also conceivable that multiple feed-material sensors 80 are provided. As shown in the exemplary embodiment, the feed-material sensor 80 may be a camera. The camera may comprise a lens. A sensor-holding device may be used to hold the feed-material sensor(s) 80 to the material processing device 10. The sensor-holding device may be a pole, to which the feed-material sensor(s) 80 is/are attached. The feed-material sensor 80 can be designed as such and/or in combination with a lens to detect a measuring range in the area of the conveyor device 23.

During operation of the material processing device 10, material to be processed is conveyed on the conveyor device 23 toward the crushing 50 and/or the screening plant 30. The material to be processed, which is located in the measuring range of the feed-material sensor 80, can be monitored. For instance, the condition of the material to be processed can be continuously determined.

For this purpose, the feed-material sensor 80 preferably records images that can be transmitted to a control device 100 of the material processing device 10. The control device 100 can have a data processing device, which is designed to execute image recognition algorithms to determine the nature of the material from the images. The use of object recognition algorithms is conceivable here.

However, particularly preferably, at least one artificial neural network (ANN) is used for image recognition. In particular, the at least one ANN may have been trained in advance using data sets of images having known characteristics of a property such as the feed size and/or the rock type. For instance, the ANN can recognize different classes of task sizes.

Thus, it is possible to determine the characteristic of the material that subsequently reaches the crushing 50 and/or the screening plant 30.

As further shown in FIG. 1, a level sensor 61 may be assigned to the crushing plant 50. The latter can be designed as an ultra-sound sensor. However, it is also conceivable to use other types of sensors, such as optical sensors (for instance, a camera system), radar sensors, or mechanically acting sensors. The level sensor 61 may monitor the level of material 73 to be crushed in the crusher 50.

Furthermore, a level sensor (not shown) can be assigned to the screening plant 30. It as well can be designed as an ultrasonic sensor or in the form of another type of sensor, such as an optical sensor. The level sensor of the screening plant 30 can monitor the fill level of material to be screened in the screening plant 30.

Further, provision may be made for determining a flow, preferably a volume flow, of the material to be processed. A conveyor-device sensor 82 can be provided for this purpose. The conveyor device 82 can, for instance, be designed to determine a vibration amplitude and/or a vibration frequency of the conveyor 23. It can be used to determine a speed of the material to be processed located on the conveyor device 23. An alternative design of the conveyor-device sensor 82 is also conceivable, for instance in the form of a speed sensor in the case of a conveyor device 23 designed as a conveyor belt.

To determine a volume flow, the layer thickness of the material to be processed on the conveyor device 23 can also be determined. For instance, the feed-material sensor 80 described above or alternatively a further sensor can be used for this purpose. The layer height can also be divided into several classes and evaluated using an ANN as described above.

As further shown in FIG. 1, the material processing device 10 may further comprise a discharge-conveyor sensor 90, which is used to determine a flow of processed material. As previously explained, the main discharge conveyor 40 can convey the crushed material 74 to the main discharge stockpile 74.1. The discharge-conveyor sensor 90 may comprise a belt scale 92 to determine a mass of crushed material 74 present on the main discharge conveyor 40. Furthermore, the discharge-conveyor sensor 90 can have a speed sensor for determining a conveying speed of the main discharge conveyor 40, for instance a speed sensor 93 of a drive or a deflection roller of the main discharge conveyor 40. The determined mass and conveying speed can be used to determine the conveyed mass flow. Based on the determined mass flow, it is possible, for instance, to estimate the rate of growth of the main discharge stockpile 74.1.

A stockpile sensor 94 can preferably determine a fill level of the main discharge stockpile 74.1. In particular, it is conceivable that the stockpile sensor 94 is designed as a camera, as shown here. The stockpile sensor 94 can record images of the main discharge stockpile 74.1, which images can be evaluated, for instance, by means of image processing methods or artificial intelligence methods, such as by means of the above-mentioned ANN, to determine a fill level of the main discharge stockpile 74.1. The data processing device of the material processing device 10 can perform the evaluation. A further stockpile sensor 96 can also be provided to monitor the fill level of the fine grain stockpile 71.1.

The material processing device 10 can also have an overload sensor 60. The overload sensor 60 can be used to detect an overload of the crushing plant 50. The crushing plant 50 may be overloaded, for instance, if there is uncrushable material inside the crushing chamber. Preferably, the overload sensor 60 may be a sensor that can determine a mechanical load and/or deformation of one or both of the crushing jaws 51, 52. In particular, a strain gauge may be used to detect deformation. It is also conceivable that the overload sensor 60 is designed to determine an overload on the basis of a load (power, torque) currently applied to the drive unit 12. For instance, the overload sensor may comprise a drive sensor 86.

A crushing gap sensor 88 for monitoring a current gap width of the crushing gap 56 can also be provided.

As further shown in FIG. 1, a wireless connection 140 can be established between the material processing device 10 and a mobile device 120. The wireless connection 140 can preferably be a WiFi and/or Bluetooth connection. The wireless connection 140 may be used to enable communication between the material processing device 10 and the mobile device 120. In this way, for instance, information about a plant state of the material processing device 10 can be transmitted to the mobile device 120. A user of the mobile device 120 can thus be given access to the information about the plant state.

The plant state can, for instance, be a measured value from one or more of the above-mentioned sensors, in particular a stockpile sensor 94, 96, the conveyor-device sensor 82, the discharge-conveyor sensor 90, the feed-material sensor 80, the overload sensor 60 and/or the level sensor 61. It is also conceivable that the material processing device 10 has an operating-materials sensor, which is used to determine a supply of operating materials (e.g. fuels, lubricants, coolants, etc.). The plant state can then include the stock of one or more operating materials.

The mobile device 120 can be a cell phone, as shown here. Preferably, the mobile device 120 has a location sensor, in particular a GPS sensor, by means of which location data of the mobile device 120 can be determined.

It is conceivable that software, in particular an App, is executed on the mobile device 120, which App is designed for use in the context of communication between the material processing device 10 and the mobile device 120.

The material processing device 10 may include a transmitting and receiving device 110 configured to transmit and/or receive data via the wireless connection 140. The transmitting and receiving device 110 may be connected to the control device 100 of the material processing device 10 or integrated in the latter.

As further shown in FIG. 1, an external data processing device 130 may preferably be provided. The external data processing device 130 may have a memory device 130.1. A second wireless connection 141 may be established between the external data processing device 130 and the mobile device 120. Furthermore, a third wireless connection 142 may be established between the external data processing device 130 and the material processing device 10.

The second wireless connection 141 and the third wireless connection 142 may in particular be radio connections, preferably mobile radio connections, for instance GSM, UMTS, LTE, 5G, 6G and/or WiFi connections.

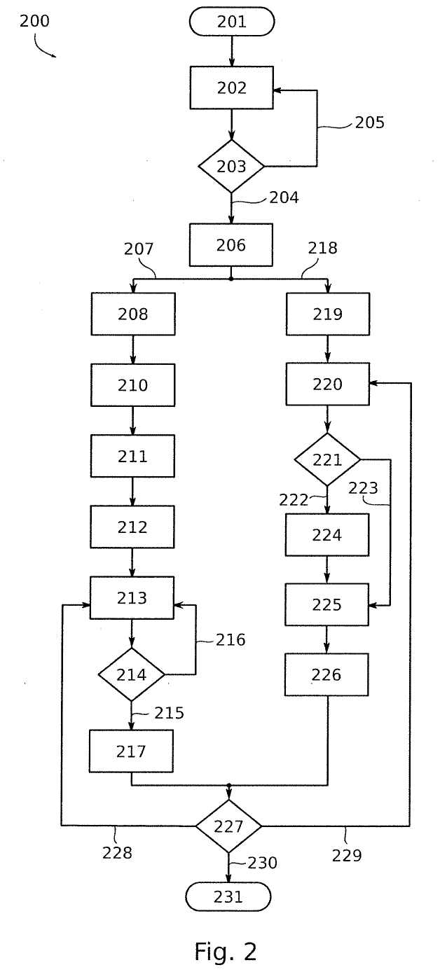

FIG. 2 shows an exemplary sequence 200 of a communication between the material processing device 10 and the mobile device 120. In accordance with this sequence 200, at the beginning 201 there is no wireless connection 140 yet between the mobile device 120 and the material processing device 10. Furthermore, preferably no wireless connection 140 has previously existed between the mobile device 120 and the material processing device 10 or connection data of a previous connection have not been stored or have been deleted in the meantime. It may therefore be a first-time connection between the material processing device 10 and the mobile device 120.

In step 202, a wireless connection 140 is now established between the material processing device 10 and the mobile device 120. To this end, the mobile device 120 is preferably located in the vicinity of the material processing device 10, in particular within a range that is less than the range of the wireless connection 140. The connection can be established manually. For instance, the connection data, in particular an identifier of the material processing device 10 and/or of the wireless connection 140 and/or a password may be entered into the mobile device 120. It is also conceivable that the mobile device 120 automatically initiates a wireless connection 140 with the material processing device 10 as soon as the range of the wireless connection 140 permits, in particular as soon as the mobile device 120 recognizes a wireless network, in particular a WiFi network of the material processing device 10.

However, it is also conceivable that step 202 comprises retrieving stored location data of the material processing device 10 from a memory of the mobile device 120 and/or the memory device 130.1 of the external data processing device 130. If, based on the stored location data of the material processing device 10 and the location data of the mobile device, determination is made that a wireless connection 140 is available between the mobile device 120 and the material processing device 10, the wireless connection can be established. Preferably, the wireless connection 140 can be established automatically, wherein a manual establishment is also conceivable, as described above.

If a check 203 reveals that the wireless connection 140 was not established in step 202 (result of the check “No” 205), step 202 may be repeated. If the result of the check is “Yes” 204, continue at step 206.

In step 206, the connection data is stored, preferably in a memory of the mobile device 120.

The sequence 200 now has two branches 207 and 218, each of which can be provided alternatively or in conjunction with each other. First, the sequence in accordance with branch 207 is described further.

In accordance with step 208, the material processing device 10 transmits its current location data to the mobile device 120 via the wireless connection 140 established in this way. Alternatively, the mobile device 120 can retrieve the current location data from the material processing device 10. In accordance with step 210, the mobile device 120 stores the location data of the material processing device 10, preferably in the memory of the mobile device 120.

Step 210 may further comprise the mobile device 120 subscribing to updated location data of the material processing device 10. In particular, to this end, provision may be made for the mobile device 120 to inform the external data processing device 130 via the second wireless connection 141 that it is connected to the material processing device 10. Provision may then be made for the external data processing device 130 to continuously transmit updated location data of the material processing device 10 to the mobile device 120 in the future, in particular if they has changed since a previous connection.

In step 211, the mobile device 120 may transmit the current location data received from the material processing device 10 to the external data processing device 130. This location data is stored by the external data processing device 130, in particular in a memory device 130.1 of the external data processing device 130 (step 212), wherein preferably an identifier of the material processing device 10, in particular a serial number, is stored in conjunction with the location data.

Preferably, the location data of the material processing device 10 may be checked continuously or at regular or irregular intervals (step 213). For instance, the material processing device 10 can transmit its current location data to the mobile device 120 continuously or at regular or irregular intervals.

The mobile device 120 can then perform a check 214 to determine whether a relevant change has occurred with respect to the location data stored in the memory. For instance, a relevant change may be that the geographical location of the material processing device 10 has changed by a specified distance, for instance by 20m. If the check does not result in a relevant change (result of the check “No” 216), the up-to-dateness of the location data of the material processing device 10 can continue to be determined continuously in accordance with step 213.

In accordance with step 217, if the result of the check is “yes” 215, the location data of the material processing device 10 may be updated locally in the memory of the mobile device 120 and transmitted by the mobile device 120 via the second wireless connection 141 to the external data processing device 130 for updating.

If the wireless connection 140 between the mobile device 120 and the material processing device 10 still exists (result of the check 227 “Yes”, path 228), the up-to-dateness of the location data of the material processing device 10 can still be continuously determined in accordance with step 213. If the wireless connection 140 no longer exists (result of the check 227 “No”, path 230), the exemplary sequence 200 is terminated.

The sequence 200 in branch 218 is explained below. Step 219 can therefore follow step 206. Step 219 comprises subscribing to the plant state and/or notification regarding the plant state of the material processing device 10 by the mobile device 120. In particular, to this end, provision may be made for the mobile device 120 to inform the external data processing device 130 via the second wireless connection 141 that it is connected to the material processing device 10. Provision may then be made for the external data processing device 130 to transmit information regarding the plant state of the material processing device 10 to the mobile device 120 in the future.

In step 220, a plant state of the material processing device 10 can be detected. The plant state can be a measured value of a sensor of the material processing device 10 or a value that considers a measured value of a sensor. For instance, it can be a fill level of a stockpile 71.1, 74.1.

A check 221 can then be performed to determine whether the plant state conforms to a target plant state or deviates therefrom. For instance, a target plant state can conform to a maximum stockpile height above which the stockpile 71.1, 74.1 has to be cleared within a specified period of time, for instance 20 minutes. As a further example, the target plant state can be a maximum filling level inside the crushing chamber. The latter can be compared to a value determined by the level sensor 61, for instance. The target plant state can preferably be stored on the mobile device 120. The mobile device 120 can therefore perform the matching of data. One advantage here can be that different target system statuses can be stored on different mobile devices 120. For instance, a higher value for a target stockpile height can be provided for a mobile device 120 that is spatially closer to the system, because a user located in the vicinity of the material processing device 10 can perform a clearing job in a shorter time, for instance in as little as 10 minutes instead of the 20 minutes mentioned above.

If the matching of data shows that there is no relevant deviation (result of the check 221 “No” 223), the mobile device 120 can transmit the plant state and the location data of the material processing device 10 to the external data processing device 130 via the second wireless connection 141 (step 225). The plant state, like the location data, can thus be made available to other mobile devices 120 for retrieval or transmission by the external data processing device 130.

However, if the matching of data reveals a relevant deviation, the check 221 produces the result “Yes” 222. It is then possible to continue at step 224, in accordance with which a display of the plant state and/or the message concerning the plant state is provided to the user on the mobile device 120, in particular visually, acoustically and/or haptically. In particular, this can be a push message that informs the user about the plant state and/or signals a need for action on the part of the user.

Alternatively or in addition to the matching of data by the mobile device 120, it is conceivable that the matching of data between the target plant state and the plant state is performed by the material processing device 10, in particular that a target plant state is stored in the control device 100 of the material processing device 10 and is compared to a measured value or a value dependent thereon. In this case, it may therefore be sufficient not to transmit the plant state, but only a message regarding the plant state, in particular a warning message, to the mobile device 120 in the event of a relevant deviation from the target plant state. This can then be brought to the attention of the user of the mobile device 120 in accordance with step 224, for instance in the form of a push notification.

Even in the event of a relevant deviation (result of the check 221 “Yes” 222), the plant state can be transmitted by the mobile device 120 to the external data processing device 130 via the second wireless connection 141 in accordance with step 225.

In accordance with step 226, the plant state, an identifier of the material processing device 10, in particular a serial number, and the location data of the material processing device 10 can be stored in the memory device 130.1 of the external data processing device 130.

Following step 226, the existence of the wireless connection 140 between the mobile device 120 and the material processing device 10 may now be re-checked (check 227). If the result of the check is “Yes” 229, continue at step 220. If the wireless connection 140 no longer exists (result of the check 227 “No”, path 230), the exemplary sequence 200 is terminated.

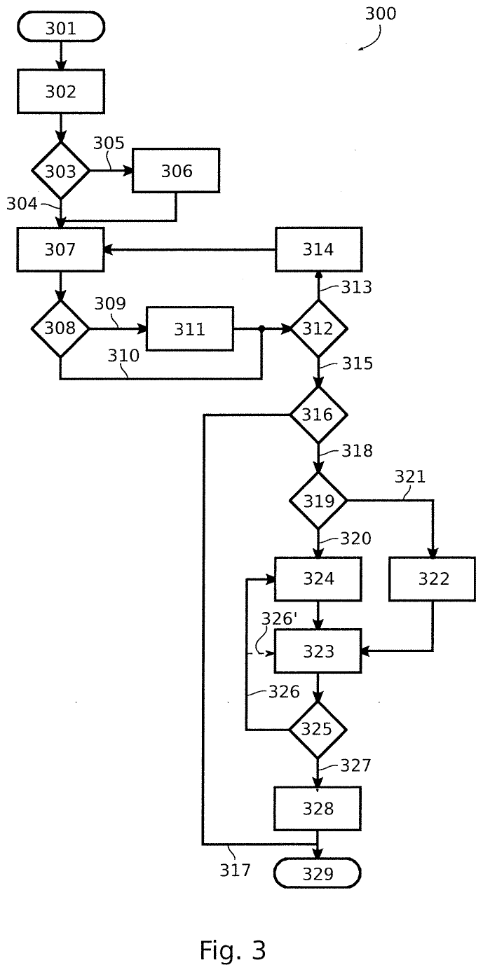

FIG. 3 shows an exemplary sequence 300 of a connection between the material processing device 10 and the mobile device 120. In accordance with this sequence, at the beginning 301 there is no wireless connection 140 yet between the mobile device 120 and the material processing device 10. However, there has already been a wireless connection 140 between the mobile device 120, in particular an initial connection, for instance in accordance with the previously described sequence 200, and/or there is location data of the material processing device 10 in the memory device 130.1 of the external data processing device 130. The location data may have been transmitted to the external data processing device 130, for instance, by the mobile device 120 during an initial connection in accordance with the above example (sequence 200), or by another mobile device 120 that was previously connected to the material processing device 10.

In step 302, the mobile device 120 may initiate a retrieval of the location data of the material processing devices 10, to which it was previously connected, from the external data processing device 130 via the second wireless connection 141. Check 303 can then be used to check whether the retrieval was successful. If the result of the check is “no” 305, the mobile device 120 can access the location data of a material processing device 10 if it has been stored in the memory of the mobile device. If the result of the check is “yes” 304, the location data can be retrieved from the external data processing device 130 and used for the further sequence.

In the next step 307, the location data of the mobile device 120 can now be compared to the location data of the material processing equipment 10. The matching of data can preferably be performed by the mobile device 120, in particular by an App installed thereon, or also by the external data processing device 130. For instance, a geographical distance between an individual material processing device 10 and the mobile device 120 can be determined.

A check 308 can then be performed to determine whether the distance between the material processing device 10 and the mobile device 120 is below a specified value. The specified value can, for instance, take into account a range of the wireless connection 140. For instance, the specified value can be 200 m. If the result of the check is “yes” 309, it can be noted in a temporary memory of the mobile device 120 in accordance with step 311 that every checked material processing device 10 is within reach. If the result of the check is “No” 310, step 311 can be skipped.

In accordance with check 312, the mobile device 120 can now check whether there are further material processing devices 10 in its memory, in particular their location data. In that case (result of the check “Yes” 313), the next or a further material processing device 10 stored in the memory of the mobile device 120 can be checked in step 314 by again performing the steps or checks 307 to 311.

If no further material processing devices 10 are now present in the memory or all material processing devices 10 have been checked in accordance with the above steps, the check 312 produces the result “No” 315.

Then, check 316 can determine whether the mobile device 120 is already connected to a material processing device 10 via a wireless connection 140. If the result of the check is “yes” 317, the sequence 300 may be terminated, provided that a simultaneous wireless connection 140 to more than one material processing device 10 is not provided.

If a wireless connection 140 to more than one material processing device 10 is provided or the result of check 316 is “no” 318, check 319 can determine whether more than one material processing device 10 is in the buffer memory of the mobile device 120, i.e., whether step 311 (noting material processing devices 10 within reach) has been completed for more than one material processing device 10. If the result of the check is “no” 321, then only one material processing device 10 is in the buffer and in accordance with step 322 the establishment of the wireless connection 140 can thus be directly suggested and/or started in accordance with step 323. It is conceivable that the mobile device 120 could automatically establish a connection. Alternatively, provision may be made for the mobile device 120 to propose establishing the connection to the user, who then has to confirm it.

If there is more than one material processing device 10 in the buffer memory of the mobile device 120, the check 319 produces the result “Yes” 320. In that case, in accordance with step 324, provision may be made for the mobile device 120 to permit the user to manually select the material processing devices 10 within reach for establishing the connection. To this end, preferably provision may be made for these to be listed in a sorted manner in accordance to the distance between the mobile device 120 and the respective material processing devices 10. However, it is also conceivable that a wireless connection 140 to the nearest material processing device 10 is automatically established, in particular that the mobile device 120 automatically starts establishing the connection.

It can now be checked 325 whether the connection was established successfully. If the result of the check is “No” 326, step 324 can be repeated. Alternatively, step 323 can be performed (path 326′) to directly conduct a new connection attempt, in particular if only one material processing device 10 was determined to be within reach. If the result of the check is “yes” 327, the location data of the facility connected to the mobile device 120 via the wireless connection 140 may be stored or updated in the memory of the mobile device 120 in step 328. The mobile device 120 may also transmit the location data to the external data processing device 130 for storage or updating via the second wireless connection 141.

Finally, the sequence can be terminated, for instance, by disconnecting 329 the wireless connection 140.

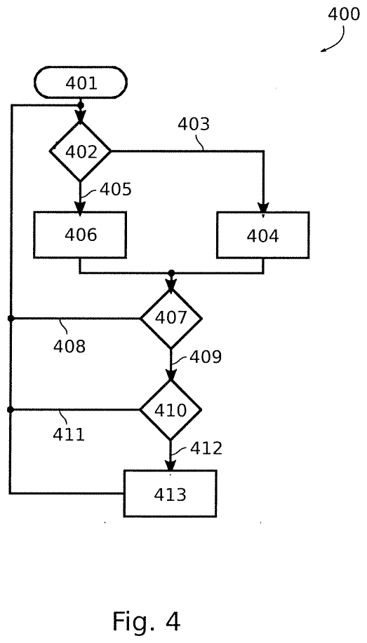

FIG. 4 shows an exemplary sequence 400 of a transmission of a plant state or a message concerning the plant state of a material processing device 10 to a mobile device 120.

After the start 401 of the sequence 400, check 402 can determine whether a wireless connection 140 exists between the mobile device 120 and the material processing device 10. In accordance with step 404, if the result of the check is “yes” 403, the plant state and/or the message regarding the plant state may be transmitted directly to the mobile device 120 via the wireless connection 140. The plant state can be a measured value of a sensor of the material processing device 10 or a value that considers a measured value of a sensor. For instance, it can be a fill level of a stockpile 71.1, 74.1.

A check 407 can then be performed to determine whether the plant state conforms to a target plant state or deviates therefrom. For instance, a target plant state can conform to a maximum stockpile height above which the stockpile 71.1, 74.1 has to be cleared within a specified period of time, for instance 20 minutes. As a further example, the target plant state can be a maximum filling level inside the crushing chamber. The latter can be compared to a value determined by the level sensor 61, for instance. The target plant state can preferably be stored on the mobile device 120. The mobile device 120 can therefore perform the matching of data.

If the matching of data reveals a relevant deviation, the check 407 leads to the result “Yes” 409. In the previously described case where there is a wireless connection 140 between the mobile device 120 and the material processing device 10 (result of the check 402 “Yes” 403), a check 410 as to whether the material processing device 10 is within a predetermined distance from the mobile device 120, for instance less than 1 km, than 500 m, than 200 m or less, may be omitted. In this case, the assumption may be made that the range of the wireless connection 140 is less than such a specified distance anyway. Accordingly, the plant state and/or the message regarding the plant state will generally be relevant for the user of the mobile device 120.

In that way, it is possible to continue at step 413, in accordance with which a display of the plant state and/or the message concerning the plant state is provided to the user on the mobile device 120, in particular visually, acoustically and/or haptically. In particular, this can be a push message that informs the user about the plant state and/or signals a need for action on the part of the user.

Alternatively or in addition to the matching of data by the mobile device 120, it is conceivable that the matching of data between the target plant state and the plant state is performed by the material processing device 10, in particular that a target plant state is stored in the control device 100 of the material processing device 10 and is compared to a measured value. In this case, it may therefore be sufficient not to transmit the plant state, but only a message regarding the plant state, in particular a warning message, to the mobile device 120 in the event of a relevant deviation from the target plant state. This can then be brought to the attention of the user of the mobile device 120 in accordance with step 413, for instance in the form of a push notification.

If check 407 produces the result “No” 408, continue at check 402.

If, however, after the start 401 of the sequence 400, the check 402 shows that there is no wireless connection 140 between the mobile device 120 and the material processing device 10 (result of the check 402 “No” 405), the plant state and/or a message concerning the plant state and/or the location of the respective material processing devices 10 can be retrieved by the mobile device 120 from the external data processing device 130 in accordance with step 406. The plant state and/or the message concerning the plant state may have been transmitted to the external data processing device 130 by, for instance, another mobile device 120 connected to the material processing device 10 by means of a wireless connection 140. It is also conceivable that the material processing device 10 has transmitted the plant state and/or the message concerning the plant state to the external data processing device 130 via a third wireless connection 142.

Thereupon, check 407 can then be performed again. There, the external data processing device 130 can also perform the matching of data between the plant state and the target plant state. It is also conceivable for the mobile device 120 and/or the material processing device 10 to perform a matching of data as described above.

Because the mobile device 120 is now not connected to the material processing device 10 by means of the wireless connection 140 in this case, determination may be made in accordance with check 410 whether the material processing device 10 is within a predetermined distance from the mobile device 120, for instance less than 1 km, than 500 m, than 200 m or less. If the distance is less than the specified value, the message may be relevant for the user of the mobile device 120, for instance. If the check 410 thus produces the result “yes” 412, it is possible to continue at step 413, in accordance with which a display of the plant state and/or the message concerning the plant state is provided to the user on the mobile device 120, in particular visually, acoustically and/or haptically. In particular, this can be a push message that informs the user about the plant state and/or signals a need for action on the part of the user.

If check 410 produces the result “No” 411, continue at check 402.

The process 400 can be performed, for instance, at regular time intervals, at irregular time intervals or continuously, for instance as an endless loop for all material processing devices 10, to which the mobile device 120 is/has been connected and/or which are already known to the mobile device 120. In particular, the process 400 can be performed as long as the software, in particular the App, is running on the mobile device 120.

Preferably, the mobile device 120 is configured by software, in particular by software executable thereon, for instance an App, to perform at least the steps or checks 208, 210, 211, 213, 214, 217, 227, 219, 224, 225, 302 to 328, 402, 404 and/or 406 and optionally 202, 203, 206, 221, 402, 407, 410 and/or 413.

The external data processing device 130 may preferably comprise software adapted to perform at least the steps or checks 212 and/or 226 and possibly 221, 407 and/or 410.

Preferably, the material processing device 10 is designed in terms of software, in particular by software which can be executed in particular by the control device 100, to perform at least the steps or checks 220 and/or possibly 211, 221, 404, and/or 407.

1-15. (canceled)

16. A method of communication between a material processing device and a mobile device, comprising:
retrieving stored location data of the material processing device from a memory of the mobile device and/or from a memory of an external data processing device;
determining location data of the mobile device;
determining an availability of a wireless connection between the mobile device and the material processing device based at least in part on the location data of the mobile device and the location data of the material processing device; and
establishing the wireless connection if the wireless connection is available.

17. The method of claim 16, further comprising:
after establishing the wireless connection, transmitting current location data of the material processing device to the mobile device via the wireless connection.

18. The method of claim 17, further comprising:
storing the current location data of the material processing device in the memory of the mobile device.

19. The method of claim 17, further comprising:
transmitting the current location data of the material processing device from the mobile device to the external data processing device via a second wireless connection; and
storing the current location data of the material processing device in the memory of the external data processing device.

20. The method of claim 16, further comprising:
transmitting current location data of the material processing device from the material processing device to the external data processing device via a further wireless connection; and
storing the current location data of the material processing device in the memory of the external data processing device.

21. The method of claim 16, further comprising:
determining current location data of the material processing device using a location sensor of the material processing device.

22. The method of claim 16, wherein:
the determining location data of the mobile device includes determining current location data of the mobile device using a location sensor of the mobile device.

23. The method of claim 16, wherein:
the retrieving the stored location data of the material processing device from the memory of the external data processing device is performed by the mobile device using a further wireless connection.

24. The method of claim 16, wherein:
the determining the availability of the wireless connection between the mobile device and the material processing device is based at least in part on a geographical distance between the mobile device and the material processing device.

25. The method of claim 16, further comprising:
determining a plant state of the material processing device;
transmitting the plant state and/or a message concerning the plant state to the mobile device using an existing wireless connection between the material processing device and the mobile device; and/or
transmitting the plant state and/or the message concerning the plant state to an external data processing device.

26. The method of claim 16, wherein:
the material processing device is a rock processing device and includes at least one crushing plant or at least one screen plant, or at least one stockpile conveyor.

27. The method of claim 16, wherein:
the mobile device is a cell phone or a tablet computer or a personal digital assistant or a notebook computer.

28. The method of claim 16, wherein:
the wireless connection between the material processing device and the mobile device includes a WiFi connection or a Bluetooth connection or an NFC connection or an RFID connection.

29. The method of claim 16, wherein:
a further wireless connection between the external data processing device and either the mobile device or the material processing device is a GSM connection or a UMTS connection or an LTE connection or a 5G connection or a 6G connection or a WiFi connection.

30. A method of transmitting a plant state and/or a message concerning a plant state of a material processing device, comprising:
determining the plant state of the material processing device;
transmitting the plant state and/or the message concerning the plant state to a mobile device using an existing wireless connection between the material processing device and the mobile device; and/or
transmitting the plant state and/or the message concerning the plant state to an external data processing device.

31. The method of claim 30, wherein:
the plant state of the material processing device includes a measured value of at least one sensor of the material processing device or depends on the measured value, and the at least one sensor is selected from the group consisting of:
a stockpile sensor configured to detect a material level of a stockpile for material processed or to be processed by the material processing device;
a conveyor-device sensor configured to detect a stream of material to be processed by the material processing device;
a discharge-conveyor sensor configured to detect a stream of processed material conveyed from the material processing device;
a feed-material sensor configured to determine information about material fed to the material processing device for processing;
an overload sensor;
a level sensor configured to determine a filling level of a crushing plant or a screening plant of the material processing device;
a crushing-gap sensor configured to determine a current gap width of a crushing gap of a crushing plant of the material processing device;
an operating-materials sensor configured to determine a supply of operating materials; and
a state-of-charge sensor configured to determine a state of charge of an energy storage device.

32. The method of claim 30, further comprising:
determining a geographical distance between the material processing device and the mobile device based at least in part on location data of the material processing device and location data of the mobile device; and
transmitting the plant state and/or the message concerning the plant state from the external data processing device to the mobile device using a second wireless connection if the geographical distance between the material processing device and the mobile device is below a predefined value.

33. The method of claim 30, further comprising:
comparing the plant state to a target plant state; and
wherein the message concerning the plant state is a warning message that signals a deviation between the plant state and the target plant state.

34. The method of claim 30, wherein:
the determining the plant state of the material processing device and the transmitting the plant state and/or the message concerning the plant state to the mobile device or to the external data processing device occur continuously.

35. The method of claim 30, wherein:
the determining the plant state of the material processing device and the transmitting the plant state and/or the message concerning the plant state to the mobile device or to the external data processing device occur at regular intervals or irregular intervals.
